(19) United States
(12) Patent Application Publication
(10) Pub. No.: US 2011/0310134 A1
(43) Pub. Date: Dec. 22, 2011

(54) DISPLAY DEVICE

(75) Inventor: Hitoshi NAKATSUKA, Osaka (JP)

(73) Assignee: FUNAI ELECTRIC CO., LTD., Osaka (JP)

(21) Appl. No.: 13/152,287

(22) Filed: Jun. 3, 2011

(30) Foreign Application Priority Data
Jun. 18, 2010 (JP) 2010-139857

(51) Int. Cl. G09G 3/36; G09G 5/10

(52) U.S. Cl. 345/690; 345/102

(57) ABSTRACT

A display device with an illumination unit that causes a plurality of LED to emit light as a back-light of a liquid crystal panel that comprises a temperature calculating unit that detects a forward voltage drop of the LED, and calculates the temperature of the LED based on the detected forward voltage drop; and a control unit that controls the emission of light of the LED and/or the display of picture on the liquid crystal panel based on the calculated temperature of the LED.

### CROSS-REFERENCES TO RELATED APPLICATIONS

The present application is related to the Japanese Patent Application No. 2010-139857, Jun. 18, 2010, the entire disclosure of which is expressly incorporated by reference herein.

### BACKGROUND OF THE INVENTION

1. Field of the Invention

This invention relates to a display device.

2. Description of Related Art

A display device that uses an illumination unit as a back-light of a liquid crystal panel is known. Especially the illumination unit comprises a plurality of LED (Light Emitting Diode) to emit light for the back-light. When the LED emit light, the temperature of the LED becomes high. When the temperature of the LED becomes high enough over a certain temperature, it causes decreasing of brightness of the LED, shortening of life of the LED, and destruction of the LED. The temperature of the LED affects quality of displaying picture on the liquid crystal panel. Therefore, it is necessary to properly detect temperature of the LED as the illumination device.

A tip temperature monitoring circuit is disclosed in the Japanese Patent Application Publication No. 2008-152087 and Japanese Patent Application Publication No. 2008-152088. The tip temperature monitoring circuit is placed in a gate driver IC that chooses and drives a scanning line of a display panel, and the tip temperature monitoring circuit detects the temperature of this gate driver IC. The tip temperature monitoring circuit is equipped with a heat-sensing unit that comprises a plurality of series circuit of diodes. And the diodes are comprised of PNP transistors each of them are short-circuit between the base terminals and the collector terminals. When a certain amount of current is supplied to the heat-sensing unit, a certain amount of forward voltage drop occurs in each of the diodes. And the amount of the forward voltage drop changes depending on the temperature. Since the tip temperature monitoring circuit detects the forward voltage drop, the temperature can be detected.

Temperature sensors such as a thermistor has been used to detect the temperature of the LED so far. However, the cost of the product (a display device) would be increased if a sensor for detecting the temperature is equipped individually just for the purpose. In addition, the documents mentioned above disclose a device that detects the temperature of the gate driver IC, and it does not disclose a device to detect the temperature of the LED for the illumination device. Therefore the disclosed device could not operate to reflect the temperature of the LED as the illumination device precisely. As mentioned above, the high temperature of the LED as the illumination device causes various problems. However, those problems has not been solved correctly.

### BRIEF SUMMARY OF THE INVENTION

The present invention provides a display device that can detect the temperature of the LED as the illumination device precisely with low cost, and can carry out various processing appropriately based on the detected temperature.

One embodiment of the present invention comprises, in a display device that is equipped with an illumination unit that causes a plurality of LED to emit light as a back-light of the liquid crystal panel; a temperature calculating unit that detects a forward voltage drop of the LED, and calculates a temperature of the LED based on the detected forward voltage drop; and a control unit that controls an emission of light of the LED and/or a display of image on the liquid crystal panel based on the calculated temperature of the LED.

According to the above mentioned embodiment, in the display device, the temperature of the LED is calculated based on the forward voltage drop of the LED as the illumination device, and the display of picture on the liquid crystal panel and/or the emission of light of the LED is controlled. Therefore, the temperature of the LED is adequately detected without installation of the sensors for detecting temperature of the LED. In other words the cost is decreased being compared with conventional invention. In addition, based on the temperature of the LED, the display device can adequately perform controlling process to prevent shortening of life or destruction of the LED, or controlling process to assure the quality of displaying picture on the liquid crystal panel.

### BRIEF DESCRIPTION OF THE DRAWINGS

FIG. 1 is a block diagram showing a structure of the display device.

FIG. 2 is a figure showing the relationship between the voltage of the LED and the temperature.

### DETAILED DESCRIPTION OF THE INVENTION

As one embodiment of the present invention, the display device can be comprised of an over-drive adjusting unit that can adjust response time of the liquid crystal panel for a change of gradation of image. The temperature calculating unit calculates an environmental temperature of the display device based on the temperature of the LED, and the control unit causes the over-drive adjusting unit to change setting of the response time depending on the environmental temperature.

In addition, as another embodiment of the present invention, when the temperature of the LED increases over a predetermined threshold value, the control unit controls a LED drive unit that adjust an electric current to the LED in order to reduce the electric current or cut off the electric current to the LED by the LED drive unit.

In addition, as another embodiment of the present invention, based on a revision data that corresponds to the temperature of the LED beforehand, the control unit processes chromaticity adjustment of the LED by controlling the LED drive unit that adjusts an electric current to be supplied to the LED, and/or color correction for the image to be displayed on the liquid crystal panel.

In addition, as another more detailed embodiment of the present invention, a display device with an illumination unit that causes a plurality of LED to emit light as a back-light of a liquid crystal panel comprises

a voltage detecting circuit that detects a forward voltage drop in the LED,

a memory that records certain information beforehand,

a microcomputer that carries out certain controls based on the temperature of the LED,

a LED drive circuit that adjusts an electric current to be supplied to the LED,

an over-drive adjusting circuit that adjusts response time of the liquid crystal panel for a change of gradation of image, and

an image processing circuit that performs color correction for the image to be displayed on the liquid crystal panel, wherein

the memory at least records a temperature coefficient of the LED, a conversion data showing conversion relationship between the temperature of the LED and an environmental temperature of the display device based on electricity consumption of the LED and thermal resistance that is peculiar to the display device, an over-drive setting data that configures correspondence relationship between the environmental temperature and the response time by the over-drive adjusting circuit, a revision data about color revision that has been decided in correspondence with the temperature of the LED, and a predetermined threshold value for the temperature of the LED, and

the microcomputer

calculates the temperature of the LED based on the detected forward voltage drop and the temperature coefficient, and

calculates the environmental temperature based on the calculated temperature of the LED and the conversion data, and

decides response time that corresponds to the calculated environmental temperature by referring the over-drive setting data, then

controls the over-drive adjusting circuit in order to change the setting of the response time to the decided response time, and

in case of the temperature of the LED increases over the predetermined threshold value, controls the LED drive circuit in order to make the electric current that the LED drive circuit supplies to the LED to be reduced or cut off the current to be supplied to the LED by the LED drive circuit, and

based on the revision data that corresponds to the temperature of the LED, carries out chromaticity correction of the LED by controlling the LED drive circuit and/or color correction for the image to be displayed on the liquid crystal panel.

The embodiment of the present invention will be explained hereinafter referring to the drawings as follows.

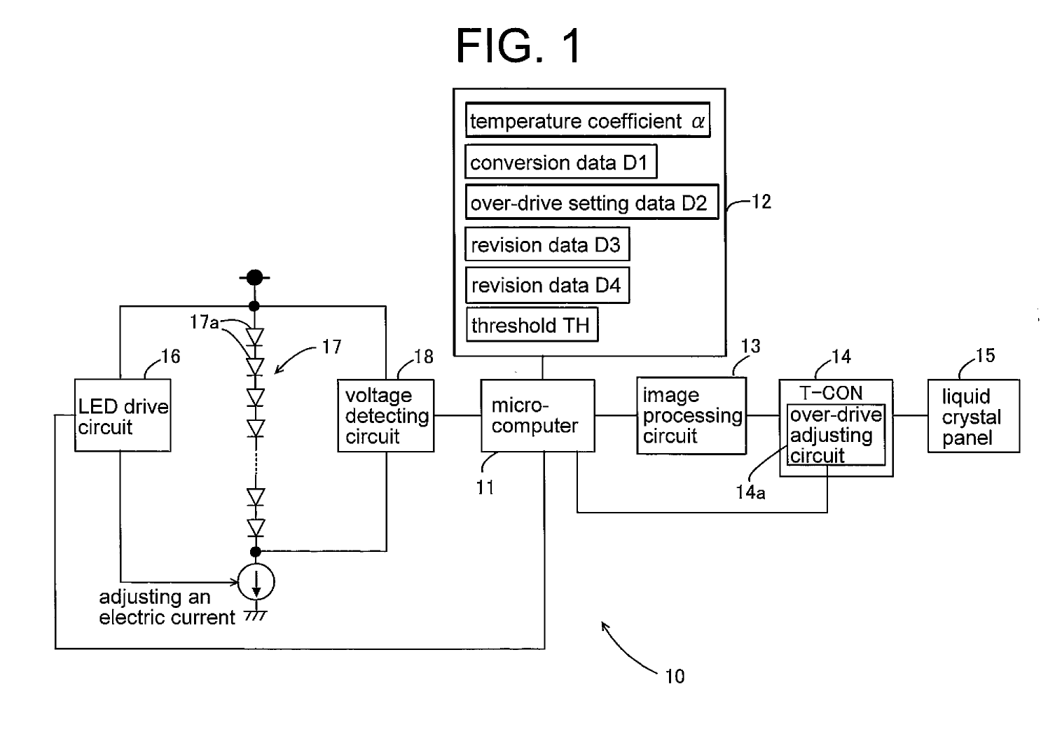

FIG. 1 shows a schematic block diagram of the display device 10 of the embodiment. The display device 10 may be a television (a liquid crystal panel television) with receiving function of the television broadcasting signal, or a display that inputs picture signal from external devices. The display device 10 comprises at least a microcomputer 11, a storage device (a memory) 12, an image processing circuit 13, a timing controller (T-CON) 14, a liquid crystal panel 15, a LED drive circuit 16, a back-light 17 and voltage detecting circuit 18.

The microcomputer 11 is connected to the memory 12, the image processing circuit 13, the T-CON 14, the LED drive circuit 16, and the voltage detecting circuit 18. The microcomputer 11 is equipped with a CPU, a ROM, a RAM. And the microcomputer 11 runs predetermined programs which are stored in ROM while using the RAM as working area. Then the microcomputer 11 controls each section of the display device 10 (while carrying out each operations as explained later), and hereby communicates with the each section.

The image processing circuit 13 inputs a picture signal as displaying object from a tuner (not illustrated) or external equipments. The image processing circuit 13 carries out various image processing such as scaling operations for the input picture signals depending on the number of the pixels of the liquid crystal panel 15, color correcting operations, and edge emphasizing operations. Then the image processing circuit 13 generates video signal that expresses a picture for a full screen and outputs it to the T-CON 14.

The T-CON 14 stores the video signal temporarily in a frame memory (not illustrated). The T-CON 14 outputs drive signal corresponding to the stored video signal to the liquid crystal panel 15 at scheduled timing The liquid crystal panel 15 comprises a large number of arranged pixels, and the T-CON 14 drives each pixel of the liquid crystal panel 15 to display a picture based on the video signal. The T-CON 14 is equipped with an over-drive (OD) adjusting circuit 14a. The over-drive adjusting circuit 14a adjusts response time of the liquid crystal panel that corresponds to change of gradation of the picture (image). The over-drive adjusting circuit 14a temporarily outputs a certain voltage (over-drive (OD) voltage) that is higher than the ordinary drive signal that corresponds to the gradation value of the video signal to the liquid crystal panel 15 in order to increase the response time. Namely, the over-drive adjusting circuit 14a can change the response time by adjusting the over-drive voltage.

The back-light 17 is an illumination unit comprising LED lines each of them are made of a series circuit of a plurality of LEDs 17, and light the liquid crystal panel 15 from its back side. FIG. 1 exemplifies only one LED line in back-light 17. However, the entire screen area of the liquid crystal panel 15 is covered by a plurality of such LED lines. In addition, the back-light 17 may be comprised of a plurality of different colored LEDs 17a. More concretely, a plurality of LED lines consisting of LEDs 17a that emit red (R) color light, LED lines consisting of LEDs 17a that emits green (G) color light, and LED lines consisting of LEDs 17a that emits blue (B) color light are equipped. As shown in the figure, Forward voltage is applied on each of the LED lines. A LED drive circuit 16 can adjust brightness value of the LED 17a by adjusting electric current to be supplied for the LED 17a. The LED drive circuit 16 can dim the back-light 17 locally. In order to do so, the LED drive circuit 16 may adjust electric current supplied to at each LED line unit, or may adjusts the electric current supplied to the LED line at each predetermined area, or may adjusts the electric current separately at each LEDs.

A voltage detecting circuit 18 detects forward voltage drop VF of the LED 17a. The voltage detecting circuit 18 may detect the forward voltage drop VF at a plurality of LEDs 17a that constitute a LED line, or may detect forward voltage drop VF at a LED 17a, or may detect mean value of a plurality of the forward voltage drop VF at a plurality of LEDs 17a. In addition, the voltage detecting circuit 18 may detect one forward voltage drop VF for the entire back-light 17, or may detect a plurality of forward voltage drops VF representing each area of the back-light 17. When there are different colored LEDs 17a, the voltage detecting circuit 18 may detect the forward voltage drop VF of each different colored LEDs 17a, or may detect the forward voltage drop VF of each different colored LEDs 17a for an entire back-light 17, or may detect the forward voltage drop VF of each different colored LEDs 17a for each area. Then the voltage detecting circuit 18 outputs detected results to the microcomputer 11.

The microcomputer 11 inputs the forward voltage drop VF from the voltage detecting circuit 18, and read out temperature coefficient α of LED 17a stored beforehand in memory 12. Then the microcomputer 11 calculates temperature Tj of LED 17a based on the forward voltage drop VF and the temperature coefficient α. The Temperature Tj is equivalent to the junction temperature of semiconductors. The temperature coefficient α is the amount of change of the voltage at each increase of 1 degree Celsius temperature, and, for example, is a value of −2 to −4 [mV/degree Celsius]. In this embodiment, a standard voltage in the stable state (for example, 25 degrees Celsius) is set. When the forward voltage drop VF at a LED 17a or the forward voltage drop VF as the mean value of the forward voltage drop VF at a plurality of LEDs 17a is detected, the microcomputer 11 divides the forward voltage drop VF (absolute value) by the temperature coefficient α (absolute value) at first, thus calculates variation amount of temperature corresponding to the forward voltage drop VF. Then the microcomputer 11 calculates temperature Tj of the LED 17a by adding the variation amount of temperature to the above mentioned stable state temperature 25 degrees Celsius. The voltage detecting circuit 18 and the microcomputer 11 correspond to the temperature calculating unit. When the forward voltage drop VF at a plurality of LED 17a (N units) is detected, the microcomputer 11 divides the forward voltage drop VF by (α×N), then calculates the variation amount for the forward voltage drop VF.

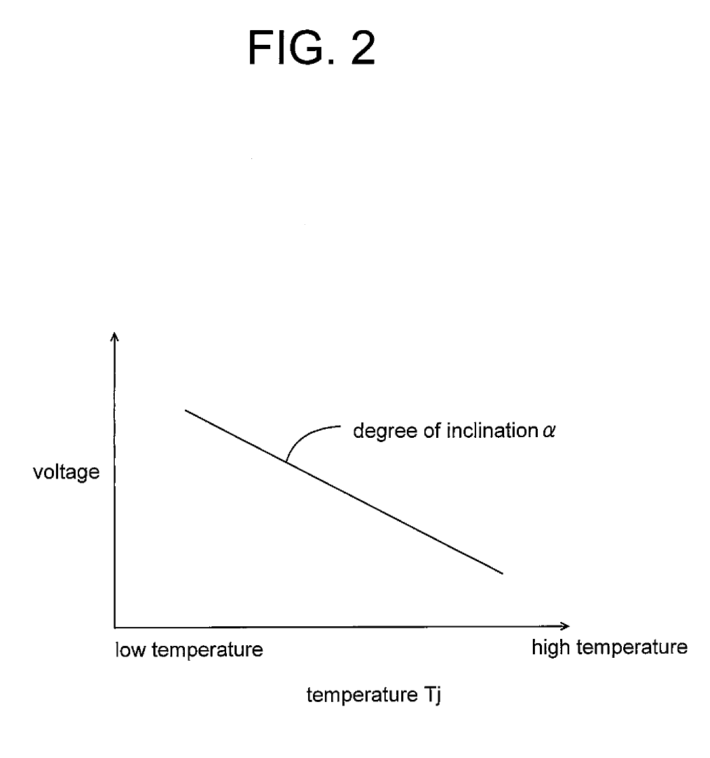

FIG. 2 shows relationship between voltage V at anode side of the LED 17a and temperature Tj by a linear function. The voltage V decreases in proportion to the increase of the temperature Tj linearly as shown in FIG. 2. In other words, the temperature Tj increases much more as the forward voltage drop VF by LED 17a increases. The degree of inclination of the linear function corresponds to the temperature coefficient α.

When the forward voltage drop VF is detected at each of the different colored LED 17a as mentioned above, the microcomputer 11 calculates the temperature Tj at each different colored LED 17a based on the temperature coefficient α stored for each of the different colored LED 17a in the memory 12 beforehand and the forward voltage drop VF for each of the different colored LED 17a. In other words the temperature coefficient as may become different value at each different colored LED 17a.

When one forward voltage drop VF is detected for an entire back-light 17, one temperature Tj that is generated by a plurality of LEDs 17a of an entire back-light 17 is calculated. When the forward voltage drop VF is detected at each area of the back-light 17, the temperature Tjs at each area are calculated. When a set of the forward voltage drop VF at each different colored LEDs 17a is detected for an entire back-light 17, one set of temperature Tj at each different colored LED 17a is calculated as a representative value for an entire back-light 17. When the forward voltage drop VF at each different colored LED 17a at each area of the back-light 17 are detected, a group of temperature Tj at each different colored LED 17a for each area is calculated.

Then the microcomputer 11 calculates environmental temperature of the display device 10 based on the temperature Tj. More concretely, the microcomputer 11 refers to the conversion data D1 (a conversion function) stored beforehand in the memory 12 that corresponds to converting relationship between the temperature Tj and the environmental temperature Ta. Then the microcomputer 11 calculates environmental temperature Ta based on the calculated temperature Tj and the conversion function. The conversion function is expressed by the following expression (1).

Tj=Rja*W+Ta (1)

In the expression (1), Rja is a thermal resistance peculiar to the display device 10, and is a prescribed numerical value. Further, W is electricity consumption of the LED 17a. The electricity consumption W may be calculated based on the electric current supplied LED 17a and the voltage, or may be a numerical value prescribed beforehand.

When one temperature Tj for an entire back-light 17 is calculated, the microcomputer 11 calculates one environmental temperature Ta for the display device 10. When temperature Tjs at each area of the back-light 17 are calculated, the microcomputer 11 calculates the environmental temperature Tas for each area of the screen are of the liquid crystal panel 15. In addition, when a set of temperature Tj for each different colored LED 17a is calculated as a representative value for the back-light 17, the microcomputer 11 calculates one environmental temperature Ta for the display device 10 based on a peculiar temperature Tj for a peculiar color that constitute each set. Further the microcomputer 11 may calculate environmental temperature Tas for each set based on each temperature Tjs for each color that corresponds to each set, then averages each environmental temperature Tas, thus calculates one environmental temperature Ta for the display device 10. In addition, when a set of temperature Tj for each different colored LED 17a is calculated, the microcomputer 11 calculates the environmental temperature Ta for each area of the screen of the liquid crystal panel 15 based on the temperature Tj for the peculiar colored temperature Tj that corresponds to each set. The microcomputer 11 may calculates the environmental temperature Ta based on each of the temperature Tj for each color that corresponds to each set. And the microcomputer 11 averages each temperature Tas at each set for each area, thus calculates environmental temperature Ta for each area of the screen of the liquid crystal panel 15.

Then the microcomputer 11 controls emission of light by LED and/or displaying of image on the liquid crystal panel 15 based on the temperature Tj and the temperature Ta. Hereinafter, a plurality of control operations (the 1st control operation-4th control operation) based on the temperature Tj and the environmental temperature Ta are explained. The display device 10 may carry out all of the following control operations, or may carry out some the following control operations.

### 1st Control Operation

Over-drive (OD) setting data D2 is stored in memory 12 beforehand. Over-drive setting data D2 is a table that is prescribed of corresponding relationship between the response time by the over-drive adjusting circuit 14a and the environmental temperature Ta. At first, the microcomputer 11 refers to the over-drive setting data D2, and decides the response time corresponding to the calculated environmental temperature Ta. Next, the microcomputer 11 notifies the over-drive adjusting circuit 14a of the T-CON 14 of the decided response time. Then the over-drive adjusting circuit 14a changes a value of the over-drive voltage that is already set to the value that corresponds to the notified response time. Hereby, the response time is being changed. The liquid crystal panel has the characteristic that the response time becomes slow in the environment where temperature is low. Therefore fast response time is set to lower environmental temperature in the over-drive setting data D2. As a result, when the environmental temperature Ta is low, the over-drive voltage is set higher. Thus it prevents the response time of the liquid crystal panel decreases when the environmental temperature Ta is low.

In addition, when microcomputer 11 calculates one environmental temperature Ta as for the display device 10, the response time notified to the over-drive adjusting circuit 14a is also one. Therefore, the over-drive adjusting circuit 14a changes the response time with the same over-drive voltage as for the entire screen area of the liquid crystal panel 15. In contrast, when the microcomputer 11 calculates environmental temperature Ta for each area of the screen of the liquid crystal panel 15, a plurality of response time corresponding to the environmental temperature Ta at each area are notified to the over-drive adjusting circuit 14a. Therefore, the over-drive adjusting circuit 14a changes response time at each area of the liquid crystal panel 15.

### 2nd Control Operation

Revision data D3 is prescribed for color correction corresponding to the temperature Tj. And such Revision data D3 is stored in the memory 12 beforehand. For example, color taste (chromaticity) of back-light 17 changes depending on a change of the temperature Tj. Based on the relationship, the image is revised in order to deny the change of the color taste. Such that the image will be revised in order to deny the change of the color taste, the revision data D3 depending on a value of temperature Tj is saved. The revision data D3 is a set of revision data to revise the image that will be an object to be displayed on the liquid crystal panel 15. For example, it is a correction function such as each RGB applied to each gradation value of RGB of the image. In the memory 12, the table that correspondences a revision data D3 (correction function for each RGB) to a temperature Tj, or the table that correspondences a revision data D3 (correction function for each RGB) to a combination of temperature Tjs for each different colored LED 17a is stored.

At first, the microcomputer 11 retrieves the revision data D3 corresponding to the calculated temperature Tj from the memory 12. Then the microcomputer 11 notifies the image processing circuit 13 of the retrieved revision data D3. And the microcomputer 11 have the image processing circuit 13 carry out color correcting operations based on the revision data D3. In other words, the image processing circuit 13 revises RGB gradation value for each pixels that constitute the picture, a processing object, by the revision data D3 in real time. For example, the color taste of the back-light 17 can be unmatched with an ideal white in the design when the temperature Tj is too high. A color correction denying such gap will be carried out to the picture. Therefore, regardless of the temperature Tj, the quality of the picture displayed on the liquid crystal panel 15 will be kept. When the microcomputer 11 calculates one temperature Tj for an entire back-light 17, (or when one set of temperature Tjs for each different colored LED 17a is calculated for an entire back-light 17), a number of the revision data D3 that will be notified to the image processing circuit 13 is one. And the image processing circuit 13 carries out the revision by the same revision data D3 for all pixels of the picture. On the other hand, when the microcomputer 11 calculates temperature Tj for each area of the back-light 17, (or when the microcomputer 11 calculates each set of the temperature Tjs for each different colored LED 17a for each area of the back-light 17), the revision data D3 corresponding to the temperature Tj for each area will be notified to the image processing circuit 13. And the image processing circuit 13 carries out the revision for each pixel of the picture by the revision data D3 corresponding to each are.

### 3rd Control Operation

The microcomputer 11 have the LED drive circuit 16 adjust the electric current to be supplied to the LED 17a based on the revision data D4 corresponding to the temperature Tj of the LED 17a. As a result, chromaticity revision of the LED 17a will be carried out. The revision data D4 is a kind of revision data for color correction that corresponds to the temperature Tj. For example, the color taste (chromaticity) of the back-light 17 becomes bluish white when the temperature Tj is too high. Control data reducing the electric current that the LED drive circuit 16 supplies to the LED 17a in order to deny the change of the chromaticity is stored beforehand as the revision data D4 that corresponds to each value of the temperature Tj. For example, the revision data D4 may be control data that is prescribed of an amount of electric current. Namely the revision data D4 may be the amount of electric current that will be supplied to each colored LEDs 17a such as red (R), green (G), and blue (B). In the memory 12, a table that correspondences a revision data D4 (control data for each RGB) to a temperature Tj, or a table that correspondences a revision data D4 (control data for each RGB) to a combination of temperature Tj for each different colored LEDs 17a is stored.

At first, the microcomputer 11 retrieves a revision data D4 that corresponds to the calculated temperature Tj from the memory 12. Then the microcomputer 11 notifies the LED drive circuit 16 of the retrieved revision data D4. And the microcomputer 11 have the LED drive circuit 16 carry out operations based on the revision data D4. In other words, the LED drive circuit 16 adjust electric current supply to the LED 17a for each color of RGB based on the revision data D4. For example, color taste (chromaticity) of back-light 17 becomes the bluish white when temperature Tj is too high. In this case, since the amount of electric current will be revised based on revision data D4, a change of the chromaticity will be resolved. As a result, the chromaticity of back-light 17 becomes ideal. In addition, when the microcomputer 11 calculates one temperature Tj for an entire back-light 17 (or when the microcomputer 11 calculates a set of temperature Tj for each different colored 17a for an entire back-light 17), a number of the revision data D4 notified to the LED drive circuit 16 is one. And the LED drive circuit 16 carries out the adjustment by the same revision data D4 to electric current supply for each LED 17a that constitutes the back-light 17. On the other hand, when the microcomputer 11 calculates temperature Tj for each area of the back-light 17, (or when the microcomputer 11 calculates each set of the temperature Tjs for each different colored LED 17a for each area of the back-light 17), the revision data D4 corresponding to the temperature Tj for each area will be notified to the LED drive circuit 16. And the LED drive circuit 16 carries out electric current adjustment for each LED 17a of the back-light 17 by the revision data D4 that corresponds to each area.

### 4th Control Operation

The microcomputer 11 carries out protection function for LED 17a when the temperature Tj of LED 17a becomes higher than the predetermined threshold value TH in order to prevent shortening of life or destruction of the LED. Threshold TH is stored beforehand in the memory 12. The microcomputer 11 compares the threshold TH with the calculated temperature Tj. The microcomputer 11 notifies the LED drive circuit 16 to perform protection function when the temperature Tj becomes higher than the threshold TH. In addition, when microcomputer 11 acquires a combination of the temperature Tj for each different colored LED 17a, the microcomputer 11 may compare the highest temperature Tj in the combination and threshold TH. In addition, the microcomputer 11 may compare threshold TH with each of the temperature Tj for each different colored LED 17a.

When the LED drive circuit 16 receives the notice of the performance of the protection function from the microcomputer 11, the LED drive circuit 16 reduces electric current supply to the LED 17a to predetermined amount. Hereby, the temperature of LED 17a reduces, shortening of life or destruction of the LED will be prevented. In addition, the microcomputer 11 compares threshold TH with temperature Tj of each different colored LED 17a. If the microcomputer detects temperature Tj of LED 17a for a part of the different color (for example R) exceeds the threshold TH, the microcomputer 11 may notifies the LED drive circuit 16 to perform the protection function only for the part of different colors. Then the LED drive circuit 16 reduces the electric current supply to the colored LED 17a to predetermined amount.

In addition, when the microcomputer 11 calculates one temperature Tj for an entire back-light 17 (or when the microcomputer 11 calculates one set of the temperature Tjs for each different colored LED 17a for an entire area of the back-light 17), the microcomputer 11 notifies the LED drive circuit 16 to perform the protection function for an entire area of the back-light 17. Then the LED drive circuit 16 performs the current supply adjustment depending on the notice. On the other hand, when the microcomputer 11 calculates the temperature Tj for each area of the back-light 17 (or when the microcomputer 11 calculates a set of temperature Tj for each different colored LED 17a at each area of the back-light 17), the microcomputer 11 compares the temperature Tj and threshold TH for each area. And, based on the result of the comparison for each area, the microcomputer 11 notifies the LED drive circuit 16 whether to perform the protection function for each area. Then the LED drive circuit 16 performs current supply adjustment for each area based on this notice.

In addition, the LED drive circuit 16 may cut off electric current supply to LED 17a when the LED drive circuit 16 receives the notice to perform the protection function from microcomputer 11. In other words, it stops the emission of light by the back-light 17. However, when the LED drive circuit 16 cuts off electric current supply to LED 17a. the LED drive circuit 16 basically does not carry out the light emission control or controls based on area. And the LED drive circuit 16 stops electric current supply to all LED 17a constituting the back-light 17.

According to the present embodiment, the microcomputer 11 calculates the temperature Tj of the LED 17a based on the forward voltage drop VF of LED 17a as an illumination unit, and further calculates environmental temperature Ta using the temperature Tj, and based on the calculated temperature Tj, Ta, the microcomputer 11 controls the emission of light of LED 17a or display on the liquid crystal panel 15. As a result, without sensors for detecting temperature as prior art, the temperature of the LED may be adequately acquired. In addition, based on the temperature of the LED, operations to prevent shortening of life or destruction of the LED (protection function) or operations to keep the quality of display (color and response time of the liquid crystal panel) can be adequately performed.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A display device with an illumination unit that causes a plurality of LED to emit light as a back-light of a liquid crystal panel that comprises
a temperature calculating unit that detects a forward voltage drop of the LED, and calculates a temperature of the LED based on the detected forward voltage drop; and a control unit that controls an emission of light of the LED and/or a display of image on the liquid crystal panel based on the calculated temperature of the LED.

2. A display device according to claim 1, further comprises
an over-drive adjusting unit that adjusts response time of the liquid crystal panel for a change of gradation of image, and
the temperature calculating unit calculates an environmental temperature of the display device based on the temperature of the LED, and the control unit causes the over-drive adjusting unit to change setting of the response time depending on the environmental temperature.

3. A display device according to claim 1, wherein
when the temperature of the LED increases over a predetermined threshold value, the control unit controls a LED drive unit that adjust an electric current to the LED in order to reduce the electric current or cut off the electric current to the LED by the LED drive unit.

4. A display device according to claim 1, wherein
based on a revision data that corresponds to the temperature of the LED beforehand, the control unit processes chromaticity adjustment of the LED by controlling a LED drive unit that adjusts an electric current to be supplied to the LED, and/or color correction for the image to be displayed on the liquid crystal panel.

5. A display device with an illumination unit that causes a plurality of LED to emit light as a back-light of a liquid crystal panel that comprises
a voltage detecting circuit that detects a forward voltage drop in the LED,
a memory that records certain information beforehand,
a microcomputer that carries out certain controls based on the temperature of the LED,
a LED drive circuit that adjusts an electric current to be supplied to the LED,
an over-drive adjusting circuit that adjusts response time of the liquid crystal panel for a change of gradation of image, and
an image processing circuit that performs color correction for the image to be displayed on the liquid crystal panel, wherein
the memory at least records a temperature coefficient of the LED, a conversion data showing conversion relationship between the temperature of the LED and an environmental temperature of the display device based on electricity consumption of the LED and thermal resistance that is peculiar to the display device, an over-drive setting data that configures correspondence relationship between the environmental temperature and the response time by the over-drive adjusting circuit, a revision data about color revision that has been decided in correspondence with the temperature of the LED, and a predetermined threshold value for the temperature of the LED, and
the microcomputer
calculates the temperature of the LED based on the detected forward voltage drop and the temperature coefficient, and
calculates the environmental temperature based on the calculated temperature of the LED and the conversion data, and
decides response time that corresponds to the calculated environmental temperature by referring the over-drive setting data, then
controls the over-drive adjusting circuit in order to change the setting of the response time to the decided response time, and
in case of the temperature of the LED increases over the predetermined threshold value, controls the LED drive circuit in order to make the electric current that the LED drive circuit supplies to the LED to be reduced or cut off the current to be supplied to the LED by the LED drive circuit, and
based on the revision data that corresponds to the temperature of the LED, carries out chromaticity correction of the LED by controlling the LED drive circuit and/or color correction for the image to be displayed on the liquid crystal panel.
